(19) United States
(12) Patent Application Publication
(10) Pub. No.: US 2004/0230571 A1
(43) Pub. Date: Nov. 18, 2004

(54) Index and query processor for data and information retrieval, integration and sharing from multiple disparate data sources

(76) Inventor: Gavin Robertson, Arlington, TX (US)

Correspondence Address: HOWISON & ARNOTT, L.L.P, P.O. BOX 741715, DALLAS, TX, 75374-1715, US

(21) Appl. No.: 10/778,818

(22) Filed: Feb. 13, 2004

Related U.S. Application Data
(60) Provisional application No. 60/464,682, filed on Apr. 22, 2003.

(51) Int. Cl. G06F 17/30

(52) U.S. Cl. 707/3

(57) ABSTRACT

A query server system that processes queries of data and information stored in one or more data sources. The query server system includes a query server, a query source interface connected to the query server for receiving queries, data and information source connected to the query server and an external index associated with said data and information source. The query server receives a query through the query source interface, processes the query using the external index to generate result-set pointers, sending the result-set pointers to the data source, receiving result set data from said data source and providing result-set data via the query source interface.

### CROSS-REFERENCE TO RELATED APPLICATIONS

This application claims priority based on U.S. Provisional Patent Application Ser. No. 60/464,682 (Atty. Dkt. No. OGPT-26,351) entitled “QUERY SERVER WITH EXTERNAL INDEX” and filed on Apr. 22, 2003.

### TECHNICAL FIELD OF THE INVENTION

This invention is related to data and information management, in particular a query server for searching multiple data sources.

### BACKGROUND OF THE INVENTION

There is an increasing need for organizations to integrate and share data and information (hereinafter referred to collectively as “data”) in near real time, internally, within the organization and externally with business partners, and other organizations. Data is either under direct/indirect control or it is not. In many cases, it is not, as data resides in legacy systems incapable of supporting modem application queries or belongs to someone else who is unwilling or unable to support external modern application queries.

Conventionally, organizations are faced with one of three unattractive choices: First, the data source itself executes queries and searches, referred to as a federated database approach, and has two variations: Live with data “as is,” and either (a) “dumb-down” queries or (b) use basic queries to isolate and filter large blocks of data to satisfy more advanced queries. In the specialized case of intra or inter-company Application-to-Application (A2A), Customer Relationship Management (CRM), Supply Chain Management (SCM), Sales Force Automation (SFA), Business-to-Business (B2B), or similar large-scale applications, agreed-upon standards can be used as a basis to implement additional indexes and data transforms for each data source, which if technically possible, could result in significant work to bring data sources up to standards. Second, the organization can move data to a data warehouse, if the data source owner is willing and able to allow. Third, the organization can alternatively drop any idea of conventional structured access to data and use an unstructured enterprise search engine approach.

In a federated database approach, queries are submitted based on a common data schema, converted to the correct syntax for individual databases, and then, individual database-specific queries are executed, and individual database results are combined, filtered, transformed to the common data schema and presented in a universal format.

This has the advantage of requiring no additional storage, and uses known, established systems. However, it is only as fast as the slowest individual database. It is generally limited to databases, and requires a complete understanding of database indexes and query performance. It can only be used for low-level data, as it does not allow high-level summaries or aggregations. It may be difficult to execute complex queries, as it could be an older system or the resources are not available to add indexes and accommodate queries. It may be difficult to use data and information from one data source to find data and information in another—a.k.a. heuristic data mining across data sources. It may be difficult to merge results—queries and data are not the same across databases. The data is “unclean” data, because there is generally no attempt at “cleaning up” the data. This can involve considerable time in configuring database-specific queries to fit broader, more complex query requirements—many queries may, as a result, involve full-table scans, which have a large detrimental effect on query performance. Some of these issues can only be overcome with cost-intensive adapters; others may not be overcome.

The data warehouse approach involves loading all data into a data warehouse, designed to accommodate the most requested data, probably de-normalized or in a large flat-file system. This data may be loaded from an operational data store (ODS) or loaded from the data warehouse to data marts and OLAP cubes for specific analysis.

This has the advantage of allowing relatively fast query responses. Only relevant data is stored. The system usually allows high-level, limited ad hoc queries.

The disadvantages of such a system include needing significant extract, transform and load (“ETL”) on the data (up to 80% of the work), particularly, data schema transforms, which introduces referential integrity issues, particularly on updates, if updates are possible. It does not generally allow for detailed drill-down. It requires significant additional storage and other resources (processing and network). Generally, a data warehouse system is not real-time. The schemas are different from transactional and operational databases, which makes it difficult to relate back. Converting from a transactional or operational database to an operational data store, to a data warehouse and then to data marts or OLAP cubes is a long, involved process, and can be expensive. Only a small handful of highly trained staff can typically use such a system. Specialized data mining and business intelligence tools are required.

An enterprise search engine approach creates an index, which is searched, and metadata and the source document link provided as a result.

The enterprise search engine is typically very fast and very comprehensive, allowing searching of multiple file formats. Little knowledge is needed of content and structure by using parsers and a universal storage format. It can accommodate very large volumes, and very complex and ad hoc Boolean-type searches.

Enterprise search engines require additional storage for indexes. The source data needs processing and is rendered unstructured. The data may be stale, depending on the refresh rate. Enterprise searching does not usually accommodate numeric searches or complex database-type queries such as table joins or range queries.

The external index and query server, hereinafter referred to as a “query server,” provides an alternative to the conventional three approaches of data warehousing, federated database and enterprise search, combining some of the best attributes of all three. With the query server, data remains at the source, indexes are built and maintained, and structured queries and unstructured search are executed against these indexes, external to the data source itself.

In a sense, it does not matter where the source data resides; the key to isolating, retrieving, ranking, merging and presenting this data, is index and query processing. A query server's control over index and query processing provides a substantial, immediate positive improvement on processes, implementation time and involvement, costs, and capabilities, but can also obviate the need for additional new processes or systems.

### SUMMARY OF THE INVENTION

The present invention disclosed and claimed herein, in one aspect thereof, comprises a query server system that processes queries of data stored in one or more data sources. The query server system includes a query server, a query source interface connected to the query server for receiving queries, a data source connected to the query server and a query index associated with said data source. The query server receives a query through the query source interface, processes the query using the query index to generate result-set pointers, sending the result-set pointers to the data source, receiving result-set data from said data source and providing result-set data via the query source interface.

### BRIEF DESCRIPTION OF THE DRAWINGS

For a more complete understanding of the present invention and the advantages thereof, reference is now made to the following description taken in conjunction with the accompanying drawings in which:

FIG. 1 illustrates a basic query server system;

FIG. 2 illustrates a detailed query server system;

FIG. 3 illustrates a flowchart for a query process;

FIG. 4 illustrates a query server system data source options and configuration;

FIG. 5 illustrates a functional block diagram of a query process;

FIG. 6 illustrates a query server system for integrating legacy and modern applications and databases;

FIG. 7 illustrates a query system for federal, local and state government, private industry and foreign authorities data sharing; and

FIG. 8 illustrates a query system for government, educational institution data sharing.

### DETAILED DESCRIPTION OF THE INVENTION

Referring now to the drawings, wherein like reference numbers are used herein to designate like elements throughout the various views, embodiments of the present invention are illustrated and described, and other possible embodiments of the present invention are described. The figures are not necessarily drawn to scale, and in some instances the drawings have been exaggerated and/or simplified in places for illustrative purposes only. One of ordinary skill in the art will appreciate the many possible applications and variations of the present invention based on the following examples of possible embodiments of the present invention.

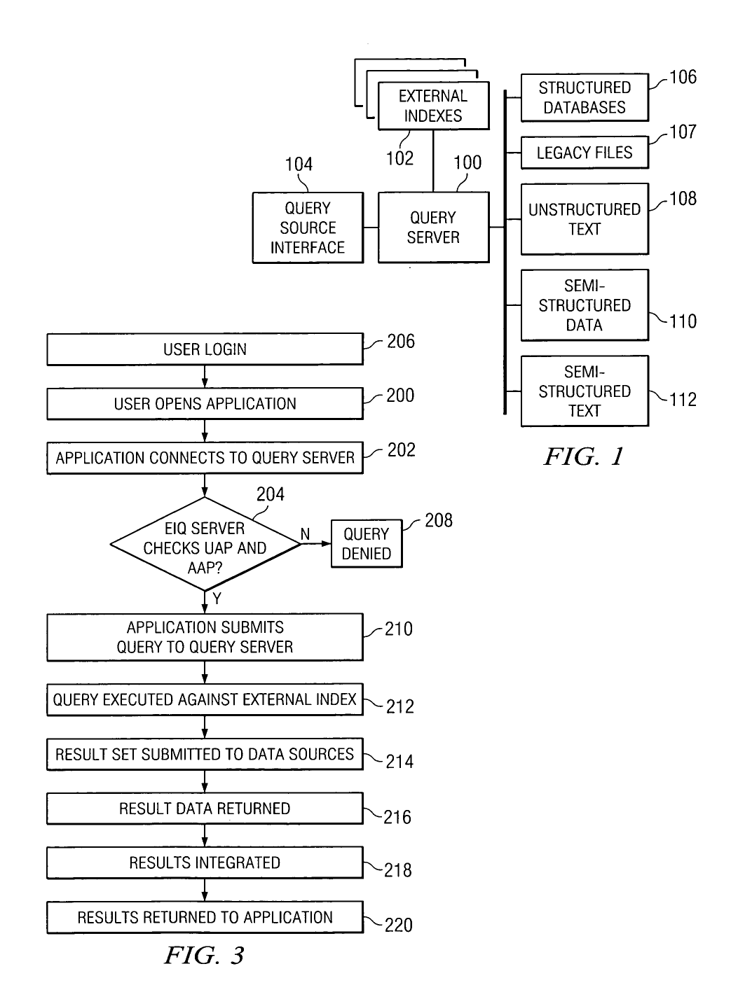

With reference to FIG. 1, a basic query server system is shown. A query server 100 has a query source interface 104 and external indexes 102. The query server 100 is connected to one or more data sources. Typical data sources may include structured databases 106, legacy files 107, semi-structured data 110, unstructured text 108 and semi-structured text 112.

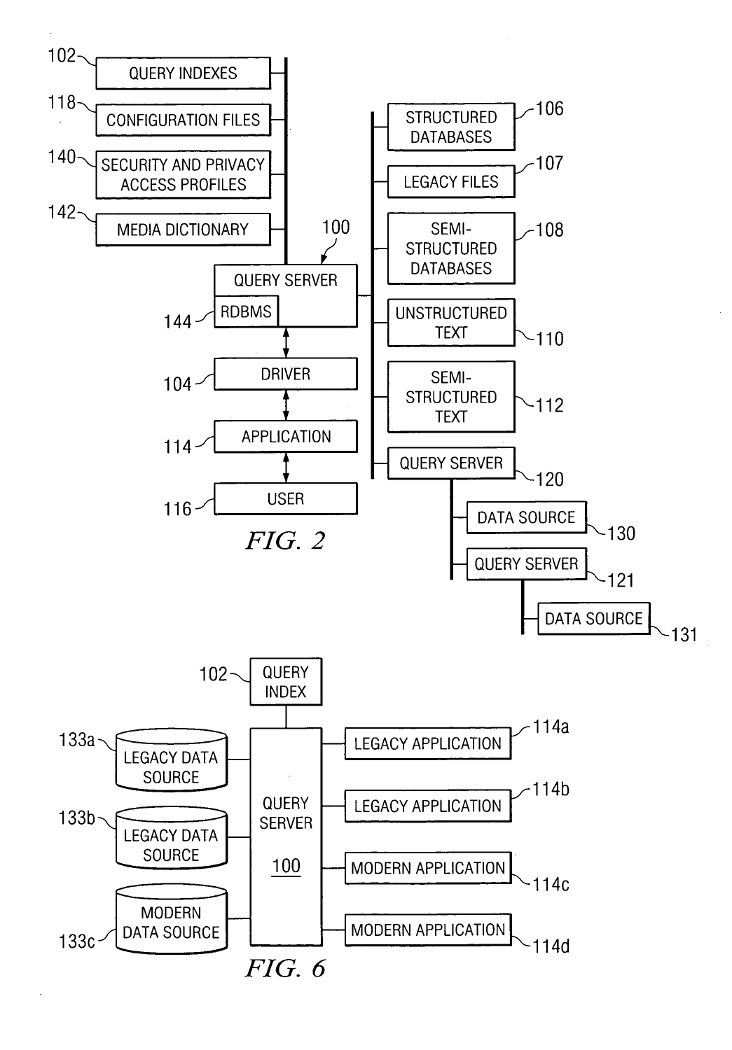

With reference to FIG. 2, the query server 100 having one or more external indexes 102 may be implemented as a software middleware data integration and sharing system that includes indexes of a variety of data sources, whether structured databases 106, legacy files 107, semi-structured data 108, unstructured text 110 and semi-structured text 112. The query server 100 executes simultaneous queries against the external indexes 102 to these multiple data sources 130 without interacting with the data in the data sources. Only after final result-sets are isolated using only the external indexes 102, is the final result-set data in the data source 130 retrieved. Final result-set data from multiple disparate date sources 130 are ranked and merged, and presented to the application 114 and end-user 116 submitting the query. No special or proprietary hardware is necessary to implement query server systems; however, there are software components that may be needed, including, but not limited to user/application logon recognition and propagation, a metadictionary 142 of common field names and attributes, configuration files for data sources 118, permission-based security and privacy access profiles 140 that include or exclude specific query or search terms and/or modify queries, mapping files for each data source consisting of metadata and tablejoin data, result-set rank and merge rules, auditable query and result-set log, and other data management rules. The query server 100 and/or external indexes 102 can also host agents that monitor changes to indexes and provide notification of any predefined matches or combinations of data.

A query server 100 in accordance with the preferred embodiment brings the best of alternative approaches in a single-point solution. This flexible solution overcomes many of the problems and hurdles to implementing alternative solutions.

Using the query server 100, all queries are executed as though the data sources were relational databases, whether structured database queries or unstructured text search. Queries and searches are executed in a similar manner. Some of the real benefits of the query server 100 are realized when both structured database queries and unstructured text search are used in combination, in the same SQL statement and on the same data sources.

With reference again to FIG. 2, a more detailed query server system is shown. A query server 100 is typically connected to an application 114 via a standard driver 104. A user 116 initiates a query through the application 114. The query server 100 is connected to memory or other storage that includes one or more external indexes 102, configuration files 118, security access profiles 140 and a metadictionary 142. The query server 100 includes a relational index and query management system (RIQMS) 144.

The query server 100 may be connected to one or more databases and information sources 130, including structured databases 106, legacy files 107, semi-structured databases 108, unstructured text 110 and semi-structured text 112. The query server 100 may also be connected to a first remote query server 120, which may be in turn connected to data sources 130. The first remote query server 120 may also be connected to a second remote query server 121, connected to a data source 131 and to many other remote query servers. Some query servers 100 may not be connected to any data source 130, but may simply pass queries to other query servers 100.

The query server 100 is typically accessed by applications 114 similar to a database through various standard drivers 104 such as ODBC, JDBC, OLE, etc.

The query server 100 may have one or more configuration files 118 that contain data source connection and logon data for one or more data sources 130. These configuration files 118 can be application-specific and invoked along with the query submitted to query server 100.

The query server 100 typically executes standard SQL for database queries and emerging standard common-use SQL for unstructured text search. The query server 100 can also perform unstructured text searches on structured data sources 130.

The query server 100 manages what data a user/application requests through a result-set schema, which is a virtual table or a virtual relational database that contains metadata standard fields to be requested in a query. Result-set schema allow applications 114 to work with data sources regardless of location, format, or data schema.

The query server 100 recognizes and honors user logons, passing on digital certificates and/or other secure logons to other query servers 100 and other systems.

The query server 100 includes the ability to use an internal relational database management system (RDBMS) to manage security and privacy access profiles 144, a managed and secure series of filters that a query has to go through before it is ultimately executed and results returned. These security and privacy access profiles 140 are created for an organization, user, application, each data source, specific content, and combinations of content, etc.

The query server 100 performs three main operations that yield result-set data back: (I) execute queries against external indexes 102 yielding result-set pointers that may be (a) record-level RowIDs, (b) primary key fields, or (c) unique combinations of fields, and are used to retrieve data from connected data sources 130, (ii) pass on queries to, and receive back result-sets from, other query servers 120 in a peer-to-peer (P2P) manner, and (iii) pass through queries to data sources 130 for native query processing and receive back result-sets from these data sources 130.

External indexes 102 are usually built using the same data fields as the data source 130 uses. The query indexes 102 may also be built using agreed-upon metadata standards that refer back to the actual data fields in the data source 130. Query server 100 uses a metadictionary 142 to map the metadata standards to actual data source fields. Each data source 130 has a simple local mapping file created and maintained by the local database administrator (DBA), and is used to convert the query to data source fields on build indexes. Also, for a data source that is an RDBMS 106, fields used to join one table to another need to be provided to the query server 100, as it uses these fields to perform table joins, used to access fields in one table from another; these are usually primary and foreign key fields. This field-level data source information can in some cases, be obtained through an driver-level command to a data source 130.

There may be differences in attributes between data source fields and metadata standard fields; however, most, if not all, of these transforms can be taken care of in the index build process and the same transform rules apply when raw source data is retrieved. Ideally, these transforms should take place at the lowest query server level, but in some cases, mapping and transforms could be performed at a higher query server level.

The external indexes 102 contain internal RowID pointers to individual virtual records; these records do not physically exist in the query server. A data source vendor may or may not make their own internal RowIDs or other form of unique record identification available. Where no internal RowIDs are available, the query server 100 uses unique indexed key fields or primary key fields to identify individual records in a data source. RowIDs or primary keys are acknowledged to be the fastest route to data in a database. The query server 100, in turn, uses a translation table to allow translation between internal query server integer RowID pointers and external data source pointers, which could be non-integer; these are one-to-one translations.

The query server 100 is capable of indexing and processing queries against multiple data sources 130. Each data source 130 has its own set of external indexes 102. In this way, queries are processed against multiple data sources 130 simultaneously. The query server 100 passes down queries for processing to other configured query servers 120; in this way, queries are processed on multiple query servers 100, each with multiple data sources 130.

A query server 100 executes an incoming query for a particular data source 130 against the external index 102 for that particular data source 130. All queries involving indexed fields are resolved using the query indexes 102 only. No temporary or interim data tables are needed; including complex queries such as table joins and range queries. Only when a final query result-set is isolated, is the actual raw data in a data source retrieved. This has many benefits including minimizing contact between the query server 100 and the data source 130, resource usage, performance, and multi-user support.

The query server 100, unlike various database/query technologies, allows at least two interim stages between a query being submitted and final results being presented; it allows the user 116 or application 114 to (I) be informed if there are any results or not, or (ii) review the number of records found in total and/or in each of the data sources 130. The user 116 or application 114 can or alternatively, need not, be informed from which data sources 130 results are coming from. Depending on the query response, the user 116 or application 114 may choose to modify the query or rank and merge rules to improve the final results.

A query server 100 sends and receives rank and merge rules along with the query, which are ideally imposed at the lowest possible query server 100; they can, however, be imposed at higher levels. These rank and merge rules can also restrict the number of responses from any individual data source 130 and thereby high-grade data results. An example where problems occur if rank and merge rules are not imposed is where maybe a few results come from a few data sources 130 and 10s to 100s of 1000s come from others; the problem lies in making sure that the few, perhaps most valuable, records from one data source are not obfuscated by the larger number of records from another data source.

A query server 100 uses the same tools used to build and maintain query indexes 102, to transform result-set data to metadata standards. Note that field-level transforms are usually all that are needed. No data schema transforms, and no extract or load operations, are required.

Query server 100 result-sets can be produced in almost any form, including, but not limited to SQL-type result tables, spreadsheets, temporary databases and XML.

The query server 100 takes a very different approach to problems facing almost any large organization: How to share data and information in near real-time without (a) adding additional large-scale systems, e.g., data warehousing, (b) overloading existing systems, e.g., federated database, and (c) losing the ability to execute structured database queries, e.g., enterprise search.

The query server 100 can externally index, query, retrieve, integrate, and share data and information from multiple sources on multiple platforms in multiple locations within an organization and across organizations simultaneously. Source data remains in place. Query server operations minimize interference with existing systems, and provides a single-point, universal and uniform system where a consistent approach is taken and results are automatically integrated and prioritized.

The query server 100 enables others outside the core organization, controlled capability to query, retrieve and integrate data and information, for example, partners, supply chain management, and government agencies.

The query server 100 accelerates queries on legacy systems and enables advanced and complex queries on such systems that may have no query processing capabilities and no standard drivers. The query server 100 may be used as a tool to transition/migrate legacy data and applications to modern systems, and allow modern applications access to legacy systems.

The query server 100 permits queries regardless of the source—structured databases 106, legacy files 107, semi-structured databases 108, unstructured text-based documents 110 (HTML, word processing, e-mail), or semi-structured text 112.

The query server 100 enables high performance from legacy database systems and large modern database systems that suffer from performance issues associated with, for example, complex queries, n-way table joins, range queries, and/or a large number of users

The query server 100 enables near real-time system updates, which are becoming increasingly necessary. As the query server 100 works with existing systems and uses existing tools and drivers, implementation costs owe significantly less than other approaches in terms of time and resources

The query server 100 enables additional query features not provided by many databases, such as combined structured queries and unstructured searches, aggregations, text searching, spatial and temporal queries, and simple data mining.

Query servers 100 can call on other query servers 120, and different query server configuration files 118 can be used for different applications 114, security and privacy access profiles 140, etc. Query servers 100 do not need to conform to a fixed hierarchical structure; lower-level data sources can be directly connected to higher-level query servers 100, bypassing intervening layers.

With reference to FIG. 3, a process for performing a query using a query server is shown. The process begins at function block 200 where the user 116 logs in to a system. The process continues at function block 201 where the user opens an application 114. The process continues at function block 202 where the application 114 connects to a query server 100. The process then proceeds to decision block 204, where the query server 100 checks the security and privacy access profiles 140, including the user access profile and application access profile for permission. This check uses information entered at function block 200, the user login. If there is no permission, the process follows the NO path to function block 208, where the query is denied. If permission is granted, the process follows the YES path to function block 210, where the application 114 submits the query to the query server 100.

Proceeding to function block 212, the query is run against the external indexes 102. The query result-set is formed and pointers are submitted to the data sources 130 in function block 214. The result data is returned from the data sources 130 in function block 216. The results are then integrated in function block 218. Integration may involve imposing rank, merge and cutoff rules that are either passed as part of the query parameters or are an inherent part of the particular query server implementation. The results are then returned to the application 114 in function block 220.

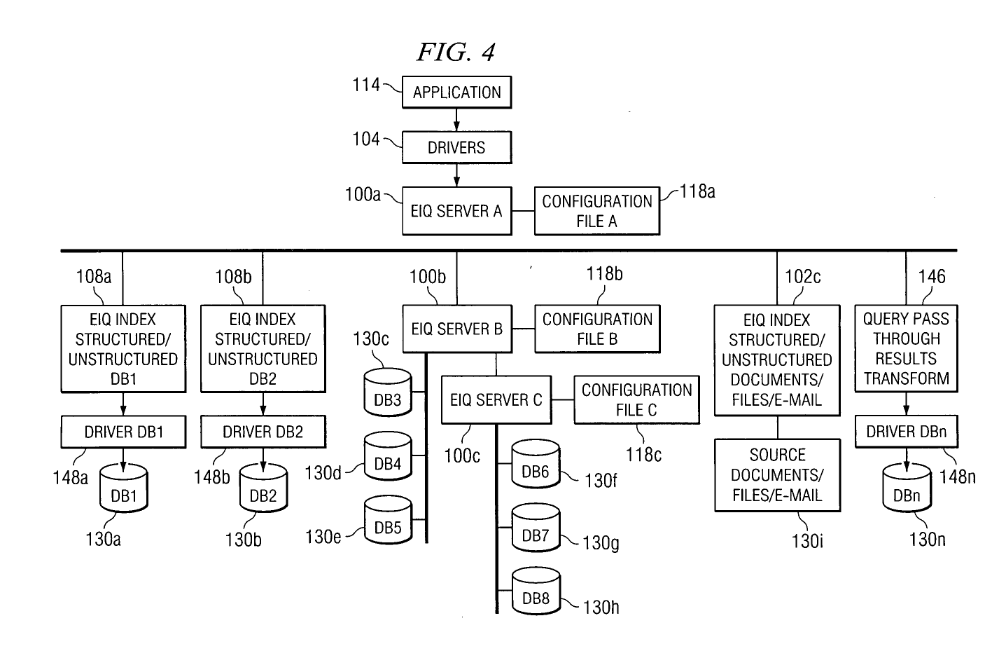

With reference to FIG. 4, an alternative block diagram of the query server system is shown. Applications 114 are connected to a first query server 100a having a configuration file 118a via standard driver 104. The first query server 100a is connected to one or more data sources 130a and 130b via database drivers 148a and 148b. Each of the data sources 130 are indexed in external indexes 102a and 102b. The first query server 100a may be connected to a second query server 100b, which may in turn be connected to a third query server 100c. The query servers 100 each have configuration files associated with them 118b and 118c. The second query server 102b may be connected to data sources 130c, 130d and 130e. The third query server 102c may be connected to data sources 130f, 130g and 130h.

The first query server may also be connected to a query index 102c for unstructured, semi-structured and text files 130i. The first query server 100a may also be connected to data sources in a query pass-through/results transform mode 146, connected to a driver 148 and a data source 130n.

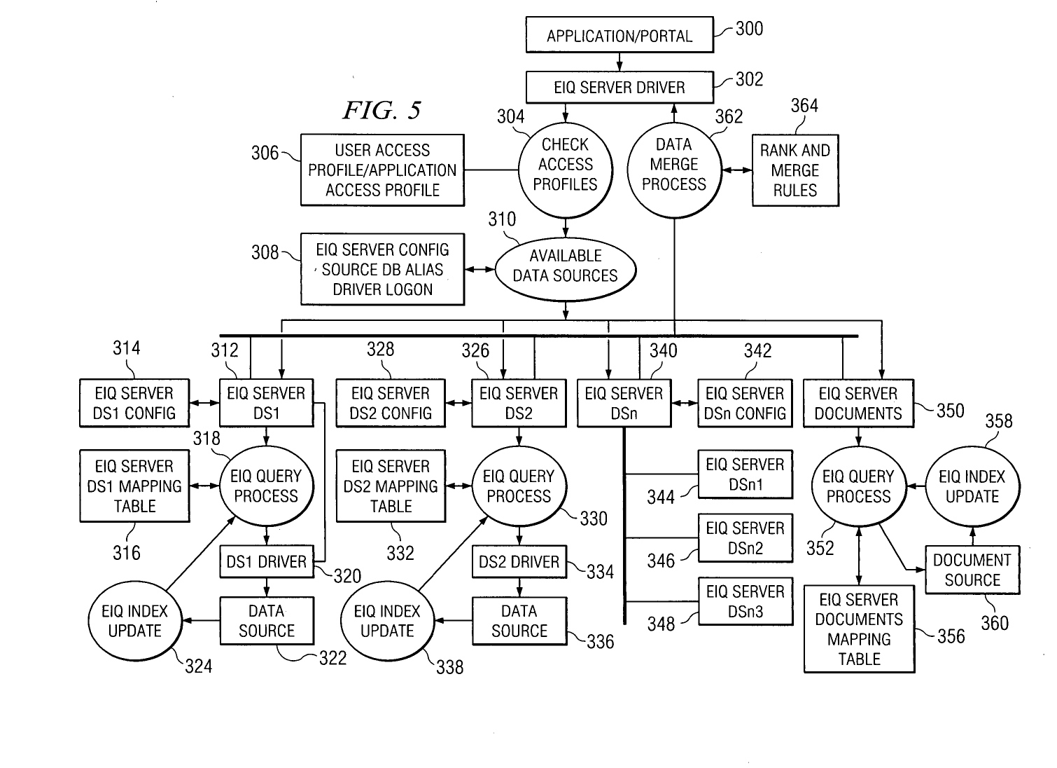

With reference to FIG. 5, a block diagram/flow chart of a query process is shown. An application 300 sends a query through a query server driver 302. The security and privacy access profiles 306 are loaded and checked 304. Reading the query server configuration files 308, a check is made for available data sources 310. The query is then sent to a first query server 312. A configuration file 314 is loaded. The query is performed on external indexes in the query process 318 and query results converted to the specific data source 322 using a mapping table 316. The query result-set pointers are sent to the data source 322 via driver 320 and results are returned to the query server 312 via driver 320. As part of a separate, independent process, query indexes 318 are updated through a query index update 324. Query index updates can occur in near real-time, incrementally or in a batch mode.

The query is further sent to a second query server 326 with a configuration file 328. The query is performed on external indexes in the query process 330 and query results converted to the specific data source using a mapping table 332. The query result-set pointers are sent to a data source 336 via driver 334. Results are returned to the query server 326 via driver 334. As part of a separate, independent process, the query index 330 is updated 338.

The query may be sent to any number of other query servers 340 with configuration files 342. The query may be processed at the query server and forwarded to one or more further query servers 344, 346 and 348. Results are returned to query server 340.

The query may also be sent to a query server 350, which contains query indexes 352 to unstructured or semi-structured information sources 360. The query is performed on the query indexes 352 and query results converted to the specific data sources using a mapping table 356. Usually, in the case of unstructured documents, result-set links to the specific data sources may be provided to the end user instead of actual data source results. As part of a separate, independent process, the query index 352 is updated 358.

The results from each of the data sources undergo a data rank and merge process 362 which is performed using rank and merge rules 364. The result-set data is then sent to the application 300 via driver 302.

With reference to FIG. 6, a query server system is shown for integrating legacy applications 114a and 114b, modem applications 114c and 114d, as well as legacy data sources 130a and 130b, and modem data sources 130c. The query server 100 uses external indexes 102 to perform the query. This configuration also allows EIQ Server to be used as an SQL transition/migration tool from legacy data sources 130a and 130b and applications 114a and 114b, to modem data sources 130c and applications 114c and 114d.

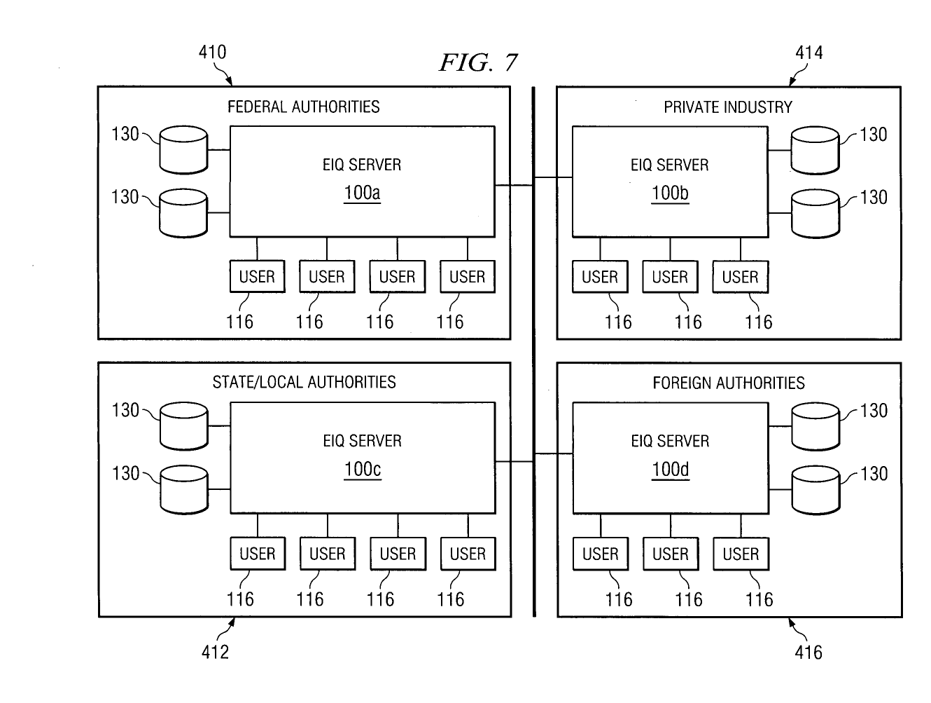

With reference to FIG. 7, which illustrates a real-time homeland security system involving multiple organizations and multiple departments within organizations is shown. Typically, departments and organizations are very protective of their data, and sharing is not common. Query servers 100 enable advanced query capabilities and controlled access to data without imposing an additional load on existing systems AND without relying on the native (or lack of) query processing of these systems. All queries are executed “virtually” within a query server 100, only final result-sets requesting specific data are retrieved from the data source, and results integrated within the query server 100. Security and privacy access profiles are established for organizations, individual users within organizations, and applications. Access rights should be down to the field-level and controlled by the data source owner.

The homeland security system could be designed with multiple Lines of Defense (LODs) to STOP terrorists from, for example: LOD1: Obtaining visas for the country, LOD2: Stepping on a plane/ship bound for the country, LOD3: Entering the country, LOD4: Activities in the country, LOD5: Leaving the country, and LOD6: Conducting activities abroad (restricting money flow, extradition, sanctions, military action and war)

Each of these LODs involves data sharing between different agencies and organizations reporting to federal authorities 410, state and local authorities 412, private industry 414, and foreign authorities 416. Similar data sharing requirements are needed at each LOD, and the same system could be used by different agencies and organizations. For the system to be effective, data must be available in near real-time.

If the system is properly implemented, it should ease travel rather than impede travel, as perhaps as many as 90% of passengers could be quickly eliminated from detailed scrutiny. It would make travel safer and more pleasant, as there would be more selective interviews and searches made, and less inconvenienced passengers.

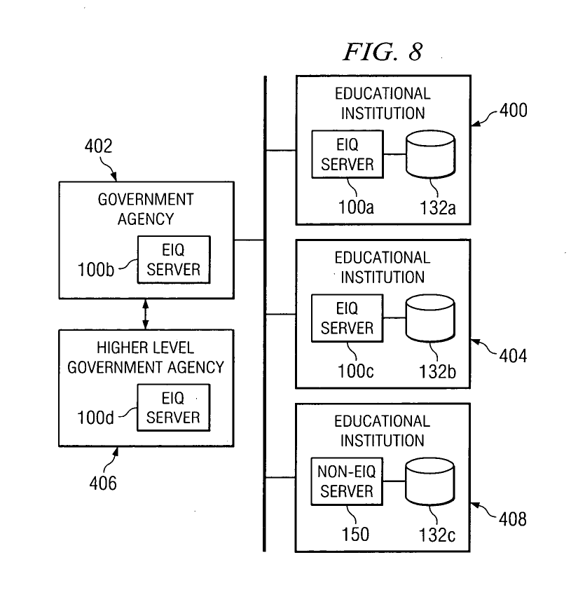

With reference to FIG. 8, which illustrates an example system allowing government agencies 402 seeking data from education institutes 400, 404, and 408, query servers 100 can be used to index and query data from each education institute in a non-intrusive and low-impact way by either installing locally or remotely. Only certain significant data needs to be indexed regularly/continuously by the query servers 100. The query servers are used to (a) risk score the data coming from the education institutes and send alerts to the government agency 402, or (b) process specific queries from a higher-level government agency query server 406. In the case of (a), specific applications could be run on high-level query servers to risk score and send alerts.

The power of such a system would be when the indexed data is used in conjunction with indexed data from other systems. In the event an education institute 408 does not have an associated query server, a native query can be made to the education institute and then mapped to query server standards on an query server (some knowledge of the education institute data sources would be required)—federated database approach, or the education institute undertakes to provide the data and information requested by the government agency in a prescribed format—simple data sharing, for example, XML.

Note that in the above scenarios, the education institute would have 100% control of access to its own data sources, and the source data would stay with the education institute.

Another example of a query server application is that of a legacy system consisting of a flat-file database and many stand-alone applications. The goals are: In the short-term, to externally index and link multiple legacy data sources, enable advanced queries and fast query response, and open up these legacy data sources to modern applications. In the longer-term, to use a query server as a transition/migration tool while legacy data and eventually, legacy applications are moved to a modern system.

Some of the features needed are a combination of structured database queries and unstructured text searches on databases, records from one legacy system connected in a one-to-many manner to other systems through link mapping, and combining database queries and searches with other unstructured documents. These features may still be needed after migrating legacy systems over to modern systems.

A query server's functionality can change over time by applying different business rules in the query server middleware layer. No changes in the application or the source data are required. This provides tremendous flexibility and minimizes impact on systems.

There is potentially no need to see or understand applications, but there may be a need to know the type of queries currently being made and desired in the future. Multiple legacy and/or modern data sources 130 can be externally indexed, queried and integrated simultaneously; a query server 100 can de-normalize modern relational systems (virtual data warehouse) for legacy applications and normalize (to a limited extent) legacy flat-file systems for modern applications.

An example of a query server application with legacy systems is where an organization needs to access multiple legacy data systems to run payroll and other HR systems, and eventually migrate legacy data over to a modern database system for use by modern applications; however, these multiple legacy data systems are multiple types, platforms, locations, schemas, and field names. There is an immediate, short-term need for the payroll system to have a unified view of the disparate legacy data, and a longer-term goal of migrating legacy data over to a modem database.

A solution would be a combination of the multiple data and information sharing solution and the transition/migration tool solution. The solution could be implemented in other organizations, wherever the same situation exists. It is also possible to enable higher-level payroll and other HR systems to be run against lower-level systems for a better overview.

A typical example of where query servers 100 can be used is where a large company has grown through developing separate lines of business units (LOBUs), which were in the past allowed total freedom on IT matters, resulting in multiple separate systems. Many customers are customers of more than one LOBU, in some case, a large number of LOBUs.

In an effort to create a single company-wide view of a customer, a query server can be used to process queries against all LOBUs and their respective systems. For some single LOBUs, more than one system may need to be involved in the process. The alternative is a data warehouse, with all the associated issues.

Query server middleware offers a non-intrusive, low-impact means of gaining the latest collective view of a customer, without the huge effort required to build and maintain a data warehouse.

It will be appreciated by those skilled in the art having the benefit of this disclosure that this invention provides a system and method for performing queries using a query server. It should be understood that the drawings and detailed description herein are to be regarded in an illustrative rather than a restrictive manner, and are not intended to limit the invention to the particular forms and examples disclosed. On the contrary, the invention includes any further modifications, changes, rearrangements, substitutions, alternatives, design choices, and embodiments apparent to those of ordinary skill in the art, without departing from the spirit and scope of this invention, as defined by the following claims. Thus, it is intended that the following claims be interpreted to embrace all such further modifications, changes, rearrangements, substitutions, alternatives, design choices, and embodiments.

What is claimed is:

1. A query server system for processing queries of data stored in one or more information sources comprising:
a query server;
a query source interface connected to the query server for receiving queries;
a data or information source connected to the query server; and
an externally constructed query index associated with said data or information source;
wherein said query server receives a query through said query source interface, processes the query using the externally constructed query index to generate a result-set, sending said result-set to said data or information source, receiving result-set data from said data or information source and providing result-set data via said query source interface.

2. The query server system of claim 1, wherein said information source is a structure data source.

3. The query server system of claim 1, wherein said information source is a legacy data source.

4. The query server system of claim 1, wherein said information source is unstructured text.

5. The query server system of claim 1, wherein said information source is semi-structured data.

6. The query server system of claim 1, wherein said information source is semi-structured text.

7. The query server system of claim 1, wherein said query is received from an application.

8. The query server system of claim 7, wherein said application has an associated configuration file to define query parameters.

9. The query server system of claim 1, wherein said information source comprises a query server.

10. The query server system of claim 1, further comprising security and privacy access profiles for defining data source access permissions.

11. A method of processing queries of an information source comprising the steps of:
receiving a query from a query source;
determining available data or information sources;
loading query indexes corresponding to said available data or information sources;
executing said query against said query indexes to generate result-set pointers;
sending said result-set pointers to said available data or information sources;
receiving result set data from said available data or information sources; and
sending said result-set data to said query source.

12. The method of claim 11, wherein said available information sources include a structured database.

13. The method of claim 11, wherein said information sources include a legacy data source.

14. The method of claim 11, wherein said available information sources include unstructured text.

15. The method of claim 11, wherein said available information sources include a semi-structured data.

16. The method of claim 11, wherein said available information sources include semi-structured text.

17. The method of claim 11, further comprising the step of checking security and privacy access profiles for permissions.

18. The method of claim 11, further comprising the step of denying the query where the security and privacy access profiles do not allow permission.

19. The method of claim 11, further comprising the step of integrating the result set data.

20. The method of claim 11, further comprising the step of ranking, merging and imposing cutoffs on the result-set data.
